(19) United States
(12) Patent Application Publication
(10) Pub. No.: US 2006/0206335 A1
(43) Pub. Date: Sep. 14, 2006

(54) Method for remote control of an audio device

(76) Inventors: Eric Thelen, Aachen (DE); Andreas Kellner, Aachen (DE); Jan Kneissler, Aachen (DE); Holger R Scholl, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/549,236

(22) PCT Filed: Mar. 8, 2004
(86) PCT No.: PCT/IB04/50211

§ 371 Date: Sep. 12, 2005

(30) Foreign Application Priority Data
Mar. 17, 2003 (EP) 03100669.5

(51) Int. Cl. G10L 21/00

(52) U.S. Cl. 704/275; 704/246

(57) ABSTRACT

A method for remote control of an audio device (1) is described, which receives an audio data stream (A) from a transmission system. A control command in the form of an audio data sample (AM) within the audio data stream (A) is sent to the audio device (1). The received audio data stream (A) is analyzed by means of an audio sample recognition system (2) in or on the audio device (1). A recognized audio data sample (AM) is converted into control data (SD, ST) and depending on the control data (SD, ST), certain components (7, 8) of the audio device (1) are activated in a certain manner.

The invention relates to a method for remote control of an audio device. “Audio device” is taken to mean in this text any device, that is in a position to receive audio data, which are transmitted through a transmitting device—usually from an audio content provider—and to give them out to a user and/or store or further process them, for example such as a radio, a computer equipped with a respective receiving device or audio/video devices such as televisions, DVD-recorders, video recorders etc. Furthermore, the invention relates to a control device for controlling an audio device in accordance with such a method as well as a simulator device, which can be used in such a control method. Moreover, the invention relates to a respective audio device, which can be remote controlled by such a method.

In many cases it is desirable to be able to remote control audio devices at least partly from the transmission device or from the audio content provider's side. In this manner, for example, a switchover of the device from playing locally stored audio data to playing transmitted audio data can be triggered or an automatic playing of certain information on a display of the audio device can be ensured. A typical example for this is the RDS (Radio Data System) implemented recently in most car radios, which is used to output receiving channel information or traffic information on a display of the radio. In the remote control methods known so far, the control data needed for the remote control are coded in a special data form. The coded control data are then transmitted through a special data channel to the audio device, decoded by the audio device and carried out according to a local function, for example the news output on the display. For one thing, in such a method, an additional data channel is needed besides the audio channel over which the audio data are transmitted. For the other, the control data must be coded in a specified form. A person not specially trained for this purpose on part of the audio provider is therefore, without the appropriate coding device, not in a position to carry out the desired remote control.

It is an object of the present invention to indicate an alternative, simple and cost-effective remote control method for audio devices of the type mentioned at the beginning.

This objective is achieved by a method for remote control of an audio device, in which a control command is transmitted to the audio device in the form of an audio data sample within the audio data stream transmitted to the device. The received audio data stream is then analyzed in the audio device by means of an audio sample recognition system and a recognized audio data sample is converted into control data. Finally, depending on the control data, certain components of the audio device are directed in a certain manner for carrying out the local action. The term “control command” is to be understood here as a control command sequence consisting of several sub-commands.

A suitable audio device, that is controllable by such a method must have an audio sample recognition system for analysis of the received audio stream in addition to a receiving unit for an audio data stream, so as to recognize control commands in the form of audio data samples within the audio data stream. This audio sample recognition system must have a suitable interpreting unit for conversion of the recognized audio data sample in control data, to control certain components of the audio device depending on the control data.

The invention makes it possible in an extremely simple manner to influence different functions of the audio device from a remote location through any audio channel. A separate data channel is then not necessary. The control method is therefore comparatively cost-effective. What is required, however, is only a suitable audio sample recognition system on the part of the audio device, where however a simple system is often sufficient, particularly in cases where the number of the possible control commands is limited.

The dependent claims contain especially advantageous designs and modifications to the invention.

In order to keep the (computing) expenditure for the audio sample recognition system as low as possible, it is proposed in claim 2 that the received audio data stream be first pre-analyzed in respect of certain key audio data samples. Only on recognition of a certain key audio data sample, the subsequent audio data are then analyzed more precisely. The audio sample recognition system can preferably have a two-stage configuration, where one part of the audio sample recognition system carries out only the pre-analysis and compares the in-going audio data stream with a very limited number of possible key audio data sample(s) given to the audio sample recognition system. Only on reception of such a key audio data sample is the second stage of the audio sample recognition system activated, which carries out a costlier analysis of the audio data stream. Preferably, an audio data sample that corresponds to a control command is again closed with a suitable key audio data sample such that the device can register if all control data have been recognized and the second, costlier stage of the audio sample recognition system can be deactivated again.

In principle, the audio data samples can consist of any audio data such as speech, music, simple tones, noises etc. In an especially preferred embodiment, however, a speech recognition system is used as an audio sample recognition system. The audio data samples may be simple speech commands or sentences, which are recognized by the speech recognition system and subsequently interpreted to extract the control data from them, by means of which the components of the audio device can then be operated for executing the desired local action. The advantage of such a system is that, for one thing, suitable speech recognition systems of satisfactory quality are already available. The other thing is that no specific coding is needed for remote controlling the device on using natural language. It is therefore possible even for persons on the user side, without special technical qualification, e.g. program moderators, news readers etc. to use the audio devices in the desired manner.

The method according to the invention makes it possible for the transmitter side, particularly the audio content provider, to have the desired control over the audio device, so long as the control actions concerned are allowed or supported by the audio device. For example, certain operating elements of a user interface can be assigned certain functions, depending on the control commands worked out, i.e. certain function keys or softkeys of the device can be programmed in the desired manner. Furthermore, an optical output facility of the audio device i.e. a LED display etc. can be run, depending on the control commands, to provide any desired information to the user in a visual form.

Preferably, the audio data sample, which corresponds to the control data, is not output to the user or stored locally for later use, depending on a received key audio data sample and/or the received control data in common with the remaining audio data stream, but filtered beforehand from the audio data stream. It would be advisable if this filter function can be switched off. This way, the audio data sample can be output together or filtered out, depending on what kind of audio data sample it is. It can be advisable here also to output these speech commands to the user in suitable form in said preferred embodiment where the transmission of the control commands takes place in natural language. For example, the information displayed can have an additional audio output or the user can be informed about the local action triggered through the remote control, such as the programming of softkeys etc.

On the transmitter side, for example in case of an audio content provider, the control commands, if in natural language, can be input by means of a suitable speech input device, such as a microphone and integrated with the audio data stream to be transmitted. The control commands can thus be spoken-in directly at the time of creation of a certain program content.

Alternatively, the control commands can also be formed first in a non-audio representation and then converted into an audio data sample. Subsequently, these audio data samples can then be integrated with an audio data stream to be transmitted to an audio device. A control device for remote control of an audio device points to a suitable audio synthesizer, for example a speech synthesizer, to convert the control commands of the non-audio format to an audio data sample. Such an audio data synthesizer can preferably be a software module, which is implemented in a computer, for example.

The non-audio format representation can be commands in a programming language, for example. In addition, the control device has an integration facility to integrate the audio data sample then with an audio data stream to be transmitted.

The behavior of the audio device on reception of a certain audio data sample can be tested any time on the part of the sender in principle at the time of generation of the audio data sample i.e. at the audio content provider's, to whom the audio data are first sent. Preferably, the control device, however, has a special simulator facility, for example in the form of a software module having an audio sample recognition system corresponding to the audio device to check the control data present in the form of the audio data sample. Such a simulator facility can be particularly used also to check on the audio device the effect of texts spoken into the microphone as natural language control commands in the audio data stream. During a continuous and correct usage of such a simulation facility it will further be possible to prevent the audio devices from making wrong interpretations of the audio data sample and thus prevent wrong functioning from the remote control.

These and other aspects of the invention are apparent from and will be elucidated with reference to the accompanying figures.

The Figs. are as follows:

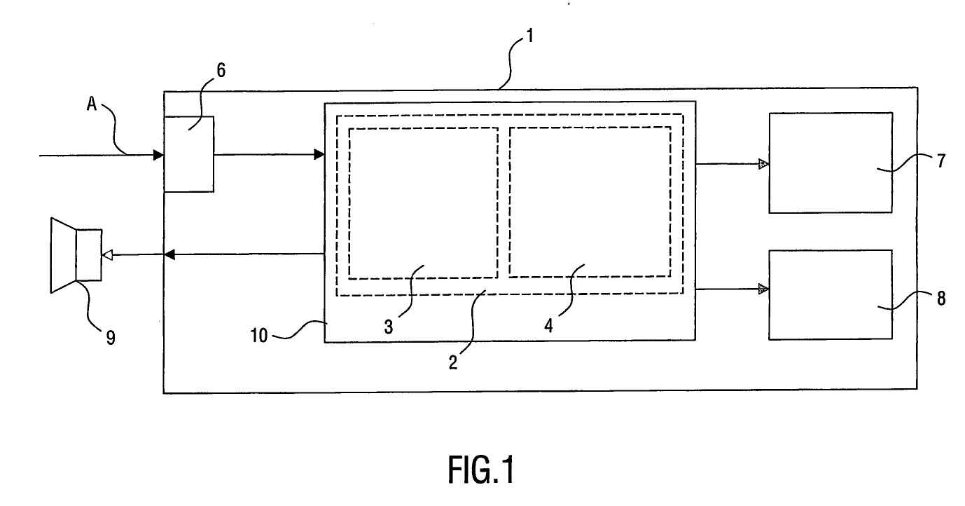

FIG. 1 shows a simplified schematic block circuit diagram of an audio device according to the invention,

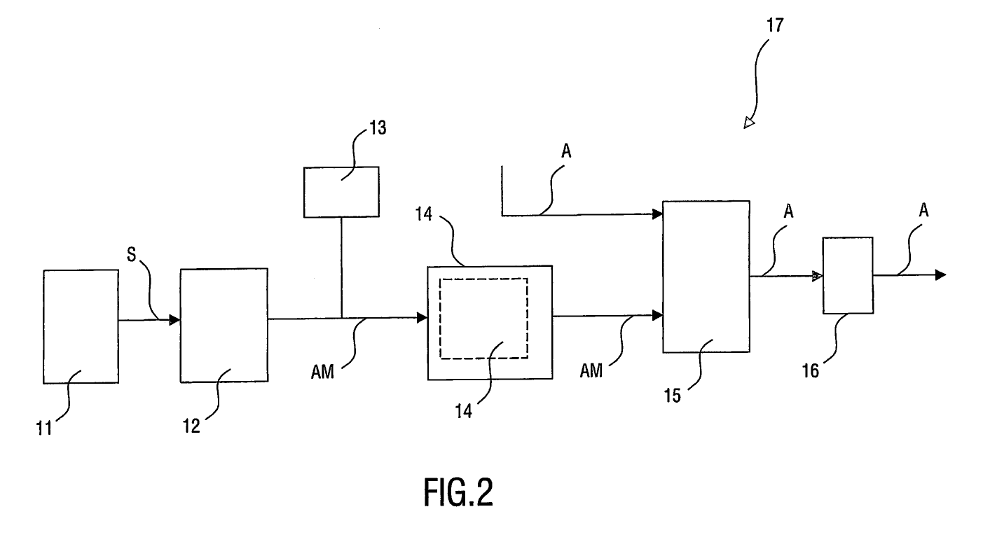

FIG. 2 shows a schematic block circuit diagram for control of an audio device according to the invention as shown in FIG. 1,

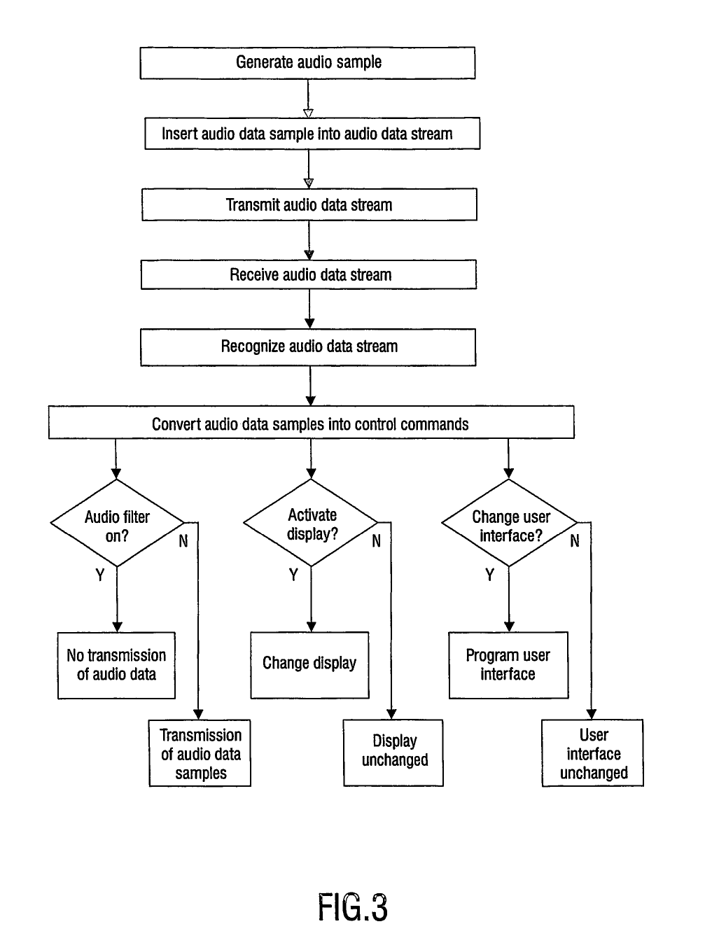

FIG. 3 shows a flowchart for illustrating the transmission and interpretation of the audio data sample.

The audio device shown in FIG. 1 shows a receiving unit 6 to receive an audio data stream A, which was transmitted by a transmission system (not shown), for example a regular radio system. A radio system is taken here to mean any system that transmits to its users, i.e. listeners or viewers, preferably digital audible radio and/or television program contents or multimedia contents. The transmission of the program contents can be done in any desired manner, wireless such as terrestrial and/or satellite-supported radio networks and/or line bound such as broadband cables.

The incoming audio data stream A is first forwarded to an audio sample recognition system 2, which is a speech recognition system in the embodiment as shown in FIG. 1. This speech recognition system 2 has a speech recognition processor 3, which recognizes the certain audio data samples AM arriving from the audio data stream A and then forwards them to a second part of the speech recognition system 2, an interpretation unit 4. The interpretation unit 4 interprets the audio data sample AM—in this case the recognized speech or voice commands—and assigns them certain control commands S_{D}, S_{T}.

The speech recognition system 2 is shown here as a component of a control device 10 in the audio device 1. This control device 10 converts the control commands S_{D}, S_{T}, determined by the interpretation unit 4 of the speech recognition system, into a form suitable for the individually controlled components 7, 8 and forwards these control commands S_{D}, S_{T} to the individual components 7, 8. The components 7, 8 then appropriately react to the commands.

In the present embodiment a component 7 is a usual display 7. On the basis of the control data S_{D} sent to the display 7, the display 7 shows certain information. The other component 8 is a user interface, sudh as a keyboard or soft keys, which are programmed with the help of the control commands S_{T}.

The control device 10 and particularly the speech recognition system 2 can be implemented entirely or partially in the form of software or software modules respectively in a computer unit, for example a central processing unit of the audio device 1. Audio devices, which are controlled already with the help of software modules in a central processing unit or the like, can also be equipped additionally—if sufficient computing capacity is available—with such a speech recognition system for remote control by means of audio data samples. The requirement is then, however, that the received audio data stream A can be fed to the processor or the speech recognition system.

The audio data A are looped through by the control device 10 and again partially output, if required, after filtering out the audio data samples AM, which contain the control commands, through an output device, which is here a simple loudspeaker 9. Alternatively—depending on the device—a direct output of the received audio data stream A can follow as a permanent feature, as shown by the broken arrow connection between the output of the receiver 6 and the loudspeaker-side output of the audio device 1.

Besides the components shown in FIG. 1, such an audio device 1, obviously has still further components customarily present in audio devices. These are, however, not shown for the sake of clarity.

Preferably, the speech recognition system 2 is set in such a manner that it initially reacts only to certain keywords or sentences and only on recognizing these keywords interprets the following speech data as control commands. Such a sequence of control commands can then again be concluded by another keyword or a key sentence. The advantage of this is that the speech recognition system 2 need not be active to the full extent all the time, but only a comparison with the possible keywords or key sentences needs to be carried out. This also reduces the probability that there would be any undesired wrong programming.

FIG. 2 shows a possible embodiment for a control device 17 for control of the audio device as shown in FIG. 1 as it can be installed on part of the transmission system.

For generating the audio data sample AM corresponding to the control commands S, this control device 17 has, on the one hand, a control command generator 11 where the control commands S can be generated, for example by means of a keyboard or some other user interface in a non-audio format representation. These control commands S are passed on to an audio synthesizer—in the present case a speech synthesizer 12,—which then generates the audio data sample which leads to the desired local action later in an audio device 1.

This audio data sample AM is then transferred to a simulator 14, which has a speech recognition system 18, which works in a manner similar to speech recognition system 2 in the audio device 1 and shows the operator of the control command generator 11, whether the audio device 1 would lead to the actions desired by him.

If the audio data sample AM has been checked, it is transferred to an Integrator 15, which integrates the audio data sample AM with an audio data stream A. This audio data stream A is then transmitted via a transmission unit 16 to the users or the audio device 1. Alternatively, the audio data sample AM in the present case—because this is natural language—can also be input directly by means of a microphone 13. The speaker is then required to know the corresponding commands and to know how the commands are interpreted by audio device 1 or the speech recognition system 2 and which actions will be triggered by the commands concerned. Advisably, the speech commands input through a microphone 13 should be tested beforehand in simulator 14, before they are integrated with the audio data stream.

Alternatively, it is also possible to use the simulator 14 as a separate device. The speaker can then first input the voice commands AM directly into the simulator 14 through a microphone 13 and test there. It is also possible to integrate the audio sample AM in the form of suitable speech commands, at the time of creation of a certain audio content, for example a radio play or an information broadcast. Then the relevant places in the audio content can at least be tested by means of a simulator 14 and, subsequently, the finished content including the contained control commands S can be transmitted through the transmission device 16.

To avoid wrong programming through defectively spoken text, the entire audio content is preferably checked in simulator 14 before being transmitted. Live transmissions should preferably be transmitted with a short delay, so that a check beforehand in a simulator facility 14 is also possible. Otherwise, it is also possible in case of a preferred embodiment to deactivate the remote control function completely by using a suitable keyword, so that it can be reactivated simply by inputting a certain keyword.

The method of working will be explained once again with reference to FIG. 3. In a first step, an audio data sample AM is generated on part of the transmission system. This audio data sample is then inserted into an audio data stream. The generation of the audio data sample can be done simultaneously with the creation of an entire audio content or a complete audio data stream. The audio data stream is transmitted to the individual audio devices over the transmission system. After an audio device 1 has received the audio data stream, the system tries to recognize certain audio data samples inside the speech recognition system 2. A recognized audio data sample is converted into control data with the help of the interpretation unit. In the embodiment shown in FIG. 3, these control data are then reviewed at the time of interpretation in respect of several operation options.

For one thing, the control data are checked to see if the audio data samples corresponding to the control commands are (to be) filtered before transmitting the audio data stream to the user. If so, the audio data samples are not co-transmitted. Otherwise the audio data samples are acoustically transmitted to the user within the audio data stream.

Further, checks are made to see if the control data are supposed to cause any control of the display of the audio device. If so, the display is modified accordingly, for example outputting information on the display. Otherwise the display remains unchanged.

Another check is done in respect of the user interface. If a reprogramming of the user interface is going to take place by means of the control data, an appropriate programming is done on the user interface, i.e. a certain key or key combination is assigned with certain functions, for example. Otherwise the user interface remains unchanged.

In principle, all these tests can also be bridged or shorted. So, for example, all the audio data including the audio data samples containing the control data can always be output.

As will be clear from this embodiment, the invention offers a possibility of controlling or programming an audio device in a simple manner on the part of the audio content provider, without the need for a special data channel or another coding. Only a formulation of the control commands in the form of naturally spoken language is required.

The invention is therefore especially suitable also for the realization of interactive radio programs, in which the individual listener or viewer has the chance to participate actively in the program planning.

An example of this is a listener survey, whether a certain contribution finds any response or not. Then, for example, the sentence can be transmitted at the end of the program contribution: “Use the following key combination for the listeners' survey: Key 1 ‘Yes’, Key 2 ‘No’. Please press now.” Here for example the term “Key assignment” is a keyword, that is recognized by the speech recognition system of the audio device, upon which the next part of the audio data stream will be examined more precisely. The recognized audio data sample key 1 ‘Yes’, key 2 ‘No’ is then recognized as control command. Then the corresponding control data are generated which are transmitted to the keyboard of the audio device. A certain key, which is designated “1”, is assigned a function, so on pressing this key, a signal report corresponding to a Yes signal is sent to the audio content provider through a return channel. At the same time, a key designated as “2” is assigned a function, so on pressing this key, an appropriate No signal is returned. The sentence “Please press now” is again recognized as a key sentence, which signals to the audio device that the actual control command has been terminated and the next audio data are not meant for remote control or remote programming, but this concerns rather normal audio data, which are to be transmitted to the user.

Another possibility is using the invention for an interactive television play, where the viewers can help decide about the progress of the story. The viewer can thus be prompted in the middle of the television play to press a certain key or key combination, so that the story progresses in a certain manner. This prompt is simultaneously recognized in the speech recognition system and so interpreted, or programmed on the device by using the keyboard that the system switches over to a certain channel on pressing the corresponding key combination on which then the rest of the story in the desired version is being broadcast.

In conclusion, it may be pointed out once more that the methods presented in the figures as well as in the description, the audio device or the broadcasting control device are only embodiments which the expert can vary to a large extent without leaving the framework of the invention. Thus, even more method steps can be added to the process described in detail. Further, functional components shown separately in the figures, for example the control command generators and the simulation facility, can in principle be also realized in one single processor or another common unit. It may be pointed out here for the sake of completeness that the use of indefinite articles such as “a” and “an” do not preclude the concerned features from being present even in multiples and the usage of the term “comprise” does not exclude the existence of other elements or steps.

1. A method for remote control of an audio device (1) which receives an audio data stream from a transmission system, in which
a control command within the audio data stream (A), is transmitted to the audio device (1) in the form of an audio data sample (AM)
and the received audio data stream (A) is analyzed in or on the audio device (1) by means of an audio sample recognition system (2)
and a recognized audio data sample (AM) is converted into control data (S_{D}, S_{T})
and depending on the control data (S_{D}, S_{T}) certain components (7, 8) of the audio device (1) are controlled in a certain manner.

2. A method as claimed in claim 1, characterized in that the received audio data stream (A) is first pre-analyzed in respect of certain key audio data samples and on recognition of a certain key audio data sample, the subsequent audio data are analyzed for determining an audio data-sample (AM) assigned to the control data (S_{D}, S_{T}).

3. A method as claimed in claim 1, characterized in that the received audio data stream (A) is analyzed by means of a speech recognition system (2).

4. A method as claimed in claim 1, characterized in that in dependence on the control data (S_{T}) certain operating elements of a user interface (8) are assigned certain functions.

5. A method as claimed in claim 1, characterized in that an optical output device (7) of the audio device (1) is controlled in dependence on the control data (SO).

6. A method as claimed in claim 1, characterized in that in dependence on a received key audio data sample and/or received control data the audio data sample (AM) corresponding to the control data is filtered out before the audio data stream (A) is transmitted to a user.

7. A method as claimed in claim 1, characterized in that the control command (5) is first formed into a non-audio format representation and then converted to an audio data sample (AM) and integrated with an audio data stream (A) to be transmitted to an audio device (1).

8. A method as claimed in claim 1, characterized in that, the control command (S) present in the form of an audio data sample (AM) is checked by means of a simulator facility (14) comprising an audio sample recognition system corresponding to the audio device (1) before integration into the audio data stream (A) and/or before transmission to an audio device (1).

9. An audio device (1) comprising
a receiving unit (6), to receive an audio data stream (A), and
an audio sample recognition system (2) for analysis of the received audio data stream (A), to recognize a control command in the form of audio data samples (AM) within the audio data stream (A), comprising an interpretation unit (4) for conversion of the recognized audio data sample (AM) into control data (Sₚ, Sᵣ), to activate certain components (7, 8) of the audio device (1) in a certain manner depending on the control data (Sₚ, Sᵣ).

10. A control device (17) for controlling an audio device (1) as claimed in claim 9, comprising an audio synthesizer (12) to convert a control command (5) from a non-audio format representation into an audio data sample (AM), and an integration device (15), to integrate the audio data sample (AM) into an audio data stream (A) to be transmitted to an audio device (1).

11. A simulator facility (14) for a control device (10) for control of an audio device (1) as claimed in claim 1, comprising an audio sample recognition system (2) corresponding to the audio device (1), to check the control command (S) present in the form of an audio data sample (AM).
